(19) United States
(12) Patent Application Publication
(10) Pub. No.: US 2024/0102131 A1
(43) Pub. Date: Mar. 28, 2024

(54) PROCESS

(71) Applicant: CEMVITA FACTORY, INC., Houston, TX (US)

(72) Inventors: James G. FLOYD, Houston, TX (US); Jesse COLANGELO-LILLIS, Houston, TX (US); Cansu FLOYD, Houston, TX (US); Elizabeth DENNETT, Houtson, TX (US)

(21) Appl. No.: 18/507,658

(22) Filed: Nov. 13, 2023

Related U.S. Application Data
(63) Continuation-in-part of application No. 18/333,008, filed on Jun. 12, 2023.
(60) Provisional application No. 63/381,174, filed on Oct. 27, 2022.
(60) Provisional application No. 63/366,336, filed on Jun. 14, 2022.

(51) Int. Cl. C22B 26/12; C22B 7/00

(52) U.S. Cl. CPC C22B 26/12; C22B 7/007

(57) ABSTRACT

A method for desorbing lithium from an adsorbent having lithium adsorbed thereon comprising: 1) providing an adsorbent having lithium adsorbed thereon, 2) contacting the adsorbent with an acid medium to desorb the lithium from the adsorbent, and 3) recovering the desorbed lithium, wherein the acid medium comprises an organic acid having a lowest pKa value of at least about 4 and/or a dicarboxylic acid which i) comprises 3 or more carbon atoms and/or ii) has a lowest pKa value of at least about 3.5.

This application is a continuation-in-part application of U.S. patent application Ser. No. 18/333,008, filed Jun. 12, 2023, which claims priority to U.S. Provisional Patent Application No. 63/366,336, filed Jun. 14, 2022, and U.S. Provisional Patent Application No. 63/381,174, filed Oct. 27, 2022. The entirety of all of the aforementioned applications in incorporated herein by reference.

### FIELD

The present application relates to processes for extracting lithium from lithium source materials such as brine using adsorbents and microorganisms and/or certain acids which may be produced by microorganisms.

### BACKGROUND

Geological reserves of hydrocarbons as an energy source are being depleted. Further, the devastating impact of carbon dioxide production from hydrocarbon combustion in driving climate change is becoming increasingly apparent. There is an urgent need to reduce reliance on and usage of hydrocarbon fuels and transition to alternative sources of energy.

However, alternative energy sourcing alone will not be sufficient to enable this transition to occur; energy transport and storage are also challenges that must be addressed to meet current climate change goals. Growing electric vehicle (EV) demand and applications including energy storage systems (ESS) will collectively require an increase in the sourcing and utilization of battery metals and other metals such as lithium, nickel, and cobalt. For example, the global lithium market is projected to grow from USD 3.83 billion in 2021 to USD 6.62 billion in 2028. This will leave an estimated gap in production of 2 million metric tons per annum by 2030.

Techniques to extract metals from the earth have developed over thousands of years. While the mining of metal ores, and the extraction of metal therefrom, is widespread, this has a profound environmental impact. In recent years, the recognition of this impact has become increasingly accepted by the mining industry and steps have been taken to modify such processes to make them more environmentally responsible.

One alternative to conventional mining approaches is to extract metals from brines. Natural brines are aqueous solutions of high ionic strength which typically contain total dissolved solids at a level around 100 to 4000′. Natural brines are typically found in underground reservoirs, often in locations with arid climates. Brines can also be man-made, for example oilfield brines which are found during deep rock penetration and drilling during oil and gas extraction.

Historically, lithium was extracted from brines using evaporitic techniques, in which brine is pumped to the surface from underground reservoirs and poured into large, shallow open-air ponds where the majority (˜90%) of the water content is lost via evaporation. This increases the concentration of the dissolved salts in the brine which then crystallize as saturation points are reached. The concentrated brines are then passed into a refining plant for crystallization of the final product.

There are multiple environmental concerns arising from the use of such evaporitic techniques. Firstly, large volumes of water (around 100 to 800 m 3) are lost via evaporation per ton of lithium carbonate recovered. This loss of water, especially in arid areas, means that the environmental burden of the process is significant. Additionally, significant volumes of additional water and other chemicals are employed in the refining plants to obtain crystallized lithium carbonate of acceptable purity.

Partially to address these concerns, an alternative technique has been developed in recent years, known as direct lithium extraction or DLE. In DLE processes, brines are contacted with lithium selective adsorbents, i.e., materials which adsorb lithium preferentially over other metals present in the brine. The lithium-loaded adsorbents are then removed from the brine (or vice versa) and treated to desorb the lithium therefrom. In many DLE processes, strong acids are used for this desorption step, which, while effective, can also damage the adsorbent, limiting its working life.

Additionally, the production of strong acids, such as sulfuric acid, is costly and energy intensive. Further, owing to the corrosive nature of such strong acids there are challenges associated with their transport and storage. When large quantities of such acids are required in remote locations, it is typically necessary to construct a plant to produce the acid and/or a specially treated tank to store it at the locality where the extraction process is conducted.

Further issues with DLE processes as conducted conventionally are discussed by Vera et al. in Nature Reviews—Earth and Environment, volume 4, March 2023, pages 149 to 165, the contents of which are incorporated herein by reference.

There exists a need for environmentally friendly, cost effective direct lithium extraction methods in which adsorbent life span is maximised.

### SUMMARY

Thus, according to one aspect of the present application, there is provided a method for desorbing lithium from an adsorbent having lithium adsorbed thereon comprising:
providing an adsorbent having lithium adsorbed thereon,
contacting the adsorbent with an acid medium to desorb the lithium from the adsorbent,
and recovering the desorbed lithium,
wherein the acid medium comprises an organic acid having a lowest pKa value of at least about 4 and/or a dicarboxylic acid which i) comprises 3 or more carbon atoms and/or ii) has a lowest pKa value of at least about 3.5.

As demonstrated in the accompanying examples, the inventors have unexpectedly found that certain acids can be used to desorb lithium from adsorbents which advantageously expand the working lifespan of those adsorbents. In preferred embodiments, the acid comprised in the acid medium may comprise acetic acid, succinic acid and/or itaconic acid.

Additionally, the inventors have also identified microbes which can produce those acids which permits the environmentally friendly production of those acids and/or the use of the microbes themselves to desorb lithium from the adsorbent.

Thus, in embodiments of the invention, the acid medium comprises a microorganism which produces an organic acid having a lowest pKa value of at least about 4 and/or a dicarboxylic acid which i) comprises 3 or more carbon atoms and/or ii) has a lowest pKa value of at least about 3.5.

Those skilled in the art will be familiar with adsorbents utilized in DLE methods. Owing to the acids used in the present application being able to effectively desorb lithium while still being relatively non-corrosive, the methods of the present application are expected to be applicable to the desorption of lithium from a range of adsorbents. Thus, in embodiments of the invention, the adsorbent is a metal adsorbent, for example one comprising aluminum and/or manganese, and/or a resin-based adsorbent, for example an ionic exchange resin.

The enhancement of the working lifespan of the adsorbent enabled by the process of the invention means that the process is particularly applicable to DLE methods. Thus, in embodiments of the invention, the process may be used to recover lithium from lithium source material such as brine and in those embodiments, the adsorbent having lithium adsorbed thereon is provided by contacting a lithium-containing source material such as brine with an adsorbent to provide an adsorbent having lithium adsorbed thereon.

### BRIEF DESCRIPTION OF THE DRAWINGS

A more complete understanding of aspects described herein, and the advantages thereof may be acquired by referring to the following description in consideration of the accompanying drawings, in which like reference numbers indicate like features.

FIG. 1 is a bar chart showing the lithium recovery (designated ‘Li’ in the chart) and manganese (indicative of adsorbent damage, designated ‘DI’ in the chart) liberated following the desorption of lithium from a manganese-containing adsorbent using a range of acid media.

FIG. 2 is a bar chart showing lithium recovery designated ‘Li’ in the chart) and manganese (indicative of adsorbent damage, designated ‘DI’ in the chart) liberated following the desorption of lithium from a manganese-containing adsorbent using a subset of the acid media at differing acid concentrations.

FIG. 3 is a bar chart showing lithium recovery designated ‘Li’ in the chart) and manganese (indicative of adsorbent damage, designated ‘DI’ in the chart) liberated following two desorptions of lithium from a manganese-containing adsorbent.

### DETAILED DESCRIPTION

In the following description of the various examples and components of this disclosure, reference is made to the accompanying drawings, which form a part hereof. It is to be understood that other methods may be utilized and that modifications may be made from the specifically described methods.

As explained above, in a first aspect of the present application, there is provided a method for desorbing lithium from an adsorbent having lithium adsorbed thereon comprising:
providing an adsorbent having lithium adsorbed thereon,
contacting the adsorbent with an acid medium to desorb the lithium from the adsorbent, and recovering the desorbed lithium,
wherein the acid medium comprises an organic acid having a lowest pKa value of at least about 4 and/or a dicarboxylic acid which i) comprises 3 or more carbon atoms and/or ii) has a lowest pKa value of at least about 3.5.

In step 1), the adsorbent having lithium adsorbed thereon may be prepared by contacting the adsorbent with a lithium source material, which may be a brine.

The adsorbent employed in the process of the present application may be of any type provided that it is capable of adsorbing lithium. In embodiments, the adsorbent may be lithium selective, for example it adsorbs lithium to a greater extent than other metals when contacted with a liquid medium comprising metals dissolved and/or suspended therein.

Those familiar with DLE extraction processes will be familiar with suitable adsorbents which may be employed in such processes. In some embodiments, the adsorbent may be a metal adsorbent, for example one comprising aluminum (e.g. hydrated alumina, lithium aluminate (e.g. lithium aluminate intercalate), lithium aluminum layered double hydroxide chloride (“LDH”), LDH modified activated alumina, LDH imbibed substrates (such as ion exchange resins, copolymers, molecular sieves or zeolites), aluminum oxide (e.g. bayerite), layered aluminate polymer blends), manganese (e.g. lithium manganese oxide), or titanium (e.g. titanium oxide). Additionally, or alternatively, the adsorbent may comprise a resin, for example an ion exchange resin or a lithium-sodium separation resin. Other types of adsorbent may also be employed, for example immobilized crown ethers.

In step 1) of the process of the invention, the lithium adsorbed on the adsorbent may be in the form of lithium cations. In certain embodiments, the lithium adsorbed on the adsorbent may be in alternative forms, for example in elemental form and/or in the form of a salt.

The adsorbent provided in step 1) of the process of the invention may be highly loaded with lithium. For example, the adsorbent may comprise up to about 100 mg, up to about 50 mg, up to about 25 mg, up to about 10 mg or up to about 5 mg of adsorbed lithium per gram of adsorbent. In embodiments, the adsorbent provided in step 1) of the process comprises about 0.1 to about 100 mg, about 0.5 mg to about 50 mg or about 1 to about 25 mg of adsorbed lithium per gram of adsorbent.

In step 2) of the process of the invention, lithium is desorbed from the adsorbent using an acid medium. Those skilled in the art will be familiar with the use of acid media comprising certain strong acids (primarily sulfuric acid) to desorb lithium from adsorbents. However, the inventors have found that the use of such strong acids damages the adsorbents, limiting their working lifespan, and, advantageously, that such damage can be avoided by using certain alternative acids instead. The acids identified by the inventors as causing minimal or no damage to adsorbents while still resulting in the desorption of significant amounts of lithium are an organic acid having a lowest pKa value of at least about 4 and/or a dicarboxylic acid which i) comprises 3 or more carbon atoms and/or ii) has a lowest pKa value of at least about 3.5.

In certain embodiments, the organic acid having a lowest pKa value of at least about 4 may be acetic acid.

In some embodiments, the dicarboxylic acid which i) comprises 3 or more carbon atoms and/or ii) has a lowest pKa value of at least about 3.5 may be succinic acid and/or itaconic acid.

It is envisaged that in embodiments, the acid medium may comprise a plurality of acids, for example a plurality of acids selected from organic acids having a lowest pKa value of at least about 4 and/or dicarboxylic acids which i) comprise 3 or more carbon atoms and/or ii) has a lowest pKa value of at least about 3.5.

The concentration of acid in the acid medium may vary depending on the application, e.g., the amount of lithium to be desorbed and/or the type of and/or quantity of adsorbent to be treated. In embodiments, the acid medium may comprise an organic acid having a lowest pKa value of at least about 4 and/or a dicarboxylic acid which i) comprises 3 or more carbon atoms and/or ii) has a lowest pKa value of at least about 3.5 at a concentration of at least about 0.01M, at least about 0.05M, at least about 0.1M, at least about 0.2M or at least about 0.5M.

In certain embodiments, the acid medium may comprise organic acid having a lowest pKa value of at least about 4 and/or a dicarboxylic acid which i) comprises 3 or more carbon atoms and/or ii) has a lowest pKa value of at least about 3.5 at a concentration of from about 0.01M to about 1M, about 0.02M to about 0.5M or about 0.05M to about 0.4M.

The amount of acid medium contacted with adsorbent in step 2) of the process of the invention may vary depending on multiple factors, including the concentration of acid in the acid medium as well as the amount of lithium to be desorbed and/or the type of and/or quantity of adsorbent employed. Broadly, the weight ratio of acid medium:adsorbent may range from about 0.5 to 1000:1, from about 1 to 500:1, from about 2 to 100:1 or from about 5 to 50:1

As mentioned above, and demonstrated in the accompanying examples, the use of certain acids avoids damage to adsorbents caused by strong acids. Thus, in embodiments of the invention, the acid medium comprises low levels of or is free of strong acids. In some embodiments, the acid medium comprises low levels or is free of one, two or all of sulfuric acid, hydrochloric acid and nitric acid. For example, in certain embodiments, the acid medium comprises about 50000 ppm or less, 20000 ppm or less, 10000 ppm or less, about 5000 ppm or less, about 1000 ppm or less, about 500 ppm or less or about 100 ppm or less of sulfuric acid. In some embodiments, the acid medium comprises about 50000 ppm or less, 10000 ppm or less, about 5000 ppm or less, about 1000 ppm or less, about 500 ppm or less or about 100 ppm or less of hydrochloric acid. In particular embodiments, the acid medium comprises about 50000 ppm or less, 10000 ppm or less, about 5000 ppm or less, about 1000 ppm or less, about 500 ppm or less or about 100 ppm or less of nitric acid.

In addition to not causing damage to adsorbents which may be utilized in DLE processes, a further advantage of the acids employed in the processes of the present application is that they may be produced microbially. This enables the production of acids in situ without the need to set up complex apparatus to synthesize those acids on site, which is particularly attractive where the process is being operated in remote locations.

While in some embodiments, acid comprised in the acid medium may be abiotically produced, additionally or alternatively, acid comprised in the acid medium may be microbially produced by an acid producing microorganism.

Surprisingly, as demonstrated in the accompanying examples, the inventors have found that not only do acid media comprising certain acids function effectively to desorb lithium from adsorbents without causing damage, but also that these results can be achieved when the media comprise microorganisms which produce those acids. Thus, in embodiments of the invention, the acid medium comprises an acid producing microorganism which produces one or more of an organic acid having a lowest pKa value of at least about 4 and/or a dicarboxylic acid which i) comprises 3 or more carbon atoms and/or ii) has a lowest pKa value of at least about 3.5.

Any type of acid producing microorganism which produces one or more of an organic acid having a lowest pKa value of at least about 4 and/or a dicarboxylic acid which i) comprises 3 or more carbon atoms and/or ii) has a lowest pKa value of at least about 3.5 may be employed in the present application. In some embodiments, the microorganism may be a fungus, a bacterium or an archaea.

In certain embodiments of the invention, the microorganism does not produce sulfuric acid, does not primarily produce sulfuric acid or does not produce solely sulfuric acid. In some embodiments of the invention, the microorganism does not produce hydrochloric acid, does not primarily produce hydrochloric acid or does not produce solely hydrochloric acid. In particular embodiments of the invention, the microorganism does not produce nitric acid, does not primarily produce nitric acid or does not produce solely nitric acid.

In some embodiments, a major product of the acid producing microorganism is an organic acid having a lowest pKa value of at least about 4 and/or a dicarboxylic acid which i) comprises 3 or more carbon atoms and/or ii) has a lowest pKa value of at least about 3.5. For example, when the acid production profile of the microorganism is assessed, the percentage by weight of all acids produced of organic acid having a lowest pKa value of at least about 4 and/or a dicarboxylic acid which i) comprises 3 or more carbon atoms and/or ii) has a lowest pKa value of at least about 3.5 is at least about 20%, at least about 30%, at least about 40%, at least about 50%, at least about 60%, at least about 70%, at least about 80% or at least about 90%.

In some embodiments, when the acid production profile of the microorganism is assessed, the percentage by weight of all acids produced of organic acid having a lowest pKa value of less than 4 and/or a dicarboxylic acid which i) comprises 2 or less carbon atoms and/or ii) has a lowest pKa value of 3.5 or less is at most about 50%, at most about 40%, at most about 30%, at most about 20%, at most about 10%, or at most about 5%.

In certain embodiments, the microorganism may be a heterotrophic organism (e.g., a heterotrophic bacteria or fungus), which produces one or more organic acids.

Those skilled in the art will be familiar with processes for screening microorganisms for acid production.

In embodiments of the invention, the acid producing microorganism produces one or more acid selected from an organic acid having a lowest pKa value of at least about 4 and/or a dicarboxylic acid which i) comprises 3 or more carbon atoms and/or ii) has a lowest pKa value of at least about 3.5, at a rate of at least 0.01 mmol/h, at least 0.02 mmol/h, at least 0.05 mmol/h, at least 0.1 mmol/h, at least 0.2 mmol/h, at least 0.05 mmol/h or at least 0.1 mmol/h. The skilled person will be familiar with methods for assessing the rate of acid production of microorganisms, e.g., using standardized colonies and growth media, assessing acid production using HPLC (high-performance liquid chromatography).

Through their own research, the inventors have identified certain acid producing microorganisms as being in production of acids as part of the present application.

Examples of fungi which may be employed include Aspergilli (e.g., Aspergillus niger, A. brasiliensis), strains belonging to the genera Nectria, Rhizopus, and strains of wood-rotting fungi, such as Phanerochaete chrysosporium, Trametes menziesii, Fomitopsis pinicol, Schizophyllum commune, Merulius tremellosus among others.

Bacterial strains which may be employed may belong to the genera Acidithiobacillus (e.g., Acidithiobacillus ferrooxidans), Bacillus (e.g., Bacillus licheniformis or Bacillus subtilis), Paenibacillus (e.g., Paenibacillus polymyxa or Paenibacillus mucilaginosus), Pseudomonas (e.g., Pseudomonas putida), Lactobacillus, Lactococcus, or Sulfobacillus.

In embodiments the acid medium may comprise a plurality of microorganism strains including the acid producing microorganism. In embodiments, the plurality of microorganisms may comprise fungal and bacterial strains. In certain embodiments, the plurality of microorganisms may comprise a plurality of bacterial strains. In some embodiments, the plurality of microorganisms may comprise a plurality of fungal strains.

In embodiments in which a plurality of microorganism strains are present in the acid medium, the plurality of microorganism strains comprise the acid producing microorganism and one or more additional microorganisms. In embodiments, some or all of the additional microorganisms may be acid producing, e.g., they may produce one or more of an organic acid having a lowest pKa value of at least about 4 and/or a dicarboxylic acid which i) comprises 3 or more carbon atoms and/or ii) has a lowest pKa value of at least about 3.5.

In some embodiments, the additional microorganisms may comprise 2, 3, 4, 5, 6, 7, 8, 9, 10 or more than 10 strains. In embodiments, the additional microorganisms may comprise 2 or more strains, 2 to 5 strains, 2 to 7 strains, 2 to 10 strains, 5 or more strains, 5 to 10 strains or 7 or more strains.

The acid producing microorganism present in the acid medium may be prepared or treated in any way to optimize it for use in the process of the present application. It may be pre-cultured in specific media and/or for specific periods of time as the skilled person would understand that varying growth media and/or culture duration may influence the profile of acids produced. In embodiments, the process includes the step of preconditioning the acid producing microorganism. For example, the acid producing microorganism may be cultured in the presence of the adsorbent, lithium, brine or other substances.

The acid producing microorganism may be native, i.e., non-engineered or may be genetically engineered.

In some embodiments, the weight percentage of lithium desorbed from the adsorbent in step 2) of the process of the invention may be at least about 5%, at least about 10%, at least about 15%, at least about 20% or at least about 25%. The amount of lithium desorbed from the adsorbent in step 2) can be determined through analysis of the lithium recovered in step 3) of the process of the invention.

In addition to comprising acid and optionally an acid producing microorganism, the acid medium employed in step 2) of the process of the present application may comprise additional components.

The acid medium has a pH of less than 7. In certain embodiments, the pH of the acid medium is less than 6 or 5. In some embodiments, the pH of the leaching medium may be from 2 to 5.

In embodiments of the invention, the acid medium may be provided in ‘ready to use’ form or may be prepared prior to operation of the process. In embodiments, the process of the invention may comprise the step of providing a composition comprising the acid producing microorganism and/or acid and mixing this with a liquid to produce the acid medium.

Thus, according to a further aspect of the present application, there is provided a composition comprising an acid producing microorganism, for example, a microorganism as disclosed herein. The composition may be an inoculum, spores, a lyophilizate, a liquid concentrate, a fungal cell, or immobilized cells or a combination thereof.

In embodiments, the composition may comprise additional microorganisms as disclosed herein.

In certain embodiments, the composition may be provided in the form of a kit comprising the composition and instructions to use it in a process as disclosed herein.

A further advantage of the process of the present application, as demonstrated in the accompanying examples, is that robust recovery of lithium can be achieved without the desorption step requiring complex apparatus or specific reaction conditions.

In embodiments of the invention, step 2) of the process is conducted in a desorption zone. The desorption zone may be comprised within a chamber or tank. In embodiments, the desorption zone is comprised within a reactor, for example a countercurrent reactor, continuous stirred tank reactor (CSTR), an immobilized cell reactor (ICR), trickle bed reactor (TBR), bubble column, gas lift fermenter, static mixer, plug-flow reactor or the like.

The process of the present application may be conducted on an industrial scale. For example, in embodiments, the acid medium contacted with the adsorbent in step 2) of the process has a volume of about 500 mL or more, about 1 liter or more, about 2 liters or more, about 5 liters or more, about 10 or more liters, about 20 or more liters, about 50 or more liters, about 100 or more liters, about 200 or more liters, about 500 or more liters, about 1,000 or more liters, about 2,000 or more liters, about 5,000 or more liters, about 10,000 or more liters, about 20,000 or more liters, about 50,000 or more liters, about 100,000 or more liters, about 200,000 or more liters or about 500,000 or more liters.

In step 2), the adsorbent may be maintained in contact with the acid medium for a maintenance period of at least about 0.1 hours, about 0.2 hours, about 0.5 hours, at least about 1 hour, at least about 2 hours, at least about 6 hours or at least about 12 hours. In some embodiments, the maintenance period may be about 1 to about 48 hours, about 1 to about 24 hours, about 1 to about 12 hours or about 1 to about 6 hours.

In embodiments of the invention, during the maintenance period, the acid medium may be agitated, e.g., via stirring, agitation and/or countercurrent flow. However, as demonstrated in the accompanying examples, this is not necessary.

During the maintenance period, the temperature of the acid medium may be controlled. For example, for some or all of the maintenance period, the temperature of the acid medium may be at least about 10° C., at least about 15° C., at least about 20° or at least about 25° C. Additionally, or alternatively, for some or all of the maintenance period, the temperature of the acid medium may be 90° C. or lower, 70° C. or lower, 50° C. or lower, 40° C. or lower, or 30° C. or lower. In embodiments, for some or all of the maintenance period, the temperature of the acid medium may be about 10° C. to about 90° C., or about 20° C. to about 80° C.

Step 3) of the process of the invention involves recovery of the desorbed lithium. Lithium recovered in step 3) of the process of the invention may be in any form. For example, the recovered lithium may be in the form of a salt, e.g., a chloride, carbonate, an oxide, a complex, a conjugate or in any other form. In embodiments, lithium may be recovered in dissolved form, or may be in insoluble form, for example as a precipitate. In some embodiments, lithium may be recovered in elemental form. In embodiments, lithium may be recovered in ionic form, for example as a cation.

In certain embodiments, the recovered lithium may form an acid conjugate with acid present in the acid medium, for example an acetate, succinate or itaconate.

In embodiments of the invention, the process may comprise the step of forming a lithium precipitate, for example lithium carbonate. This may be achieved via a heat treatment step and/or via reaction of lithium with an alkali metal carbonate, e.g., sodium carbonate.

Recovery of the desorbed lithium may be achieved, in embodiments, by extracting a laden acid medium stream from the desorption zone comprising desorbed lithium and the acid medium.

In such embodiments, the laden acid medium stream may further comprise the adsorbent and the process of the invention may optionally comprise a separation step, e.g., filtration, to separate the adsorbent from the laden acid medium stream.

Alternatively, the laden acid medium stream may be extracted from the desorption zone in such a way as to exclude or at least minimize the presence of adsorbent in the laden acid medium stream. For example, the laden acid medium stream may be extracted from the desorption zone via a filter and/or the laden acid medium stream may be extracted from a region of the desorption zone in which low levels, or no adsorbent is present (e.g., from an upper part of the desorption zone if the adsorbent has a density greater than the acid medium).

As explained herein, the process of the present application can be used to effectively desorb lithium from an adsorbent employed in a DLE process. Thus, in a further aspect of the invention, there is provided a method for recovering lithium from a lithium source material, e.g. brine in which: 1) an adsorbent is contacted with the lithium source material, such as brine resulting in the adsorbent having adsorbed lithium, thus providing an adsorbent having lithium adsorbed thereon, followed by steps 2) and 3) as described herein.

In embodiments of all aspects of the invention in which the adsorbent is contacted with a lithium source material such as a brine, this may be performed in an adsorption zone which, in some embodiments, may be the same as the desorption zone and/or may be comprised within the same apparatus as the desorption zone. In embodiments, the adsorption zone and desorption zone may be separate and/or comprised in separate apparatus.

When being contacted with the lithium source material, the adsorbent may be provided in any form. For example, it may be dispersed in particulate form in an adsorption zone. In some embodiments, the adsorbent may be arranged so as to optimize contact with the lithium source material and/or adsorption of lithium from the source material. For example, the adsorbent may be located in a column (e.g., a packed column) through which the lithium source material may be fed. Additionally, or alternatively, the adsorbent may be located in a bed (e.g., a packed bed) over and/or through which the lithium source material may be fed.

In embodiments in which the adsorbent is in particulate form, the average diameter of the particles may be from about 1 to about 500 microns, about 1 to about 200 microns, about 1 to about 100 microns or about 1 to about 50 microns.

As will be appreciated from the disclosure herein, in preferred embodiments, the lithium source material is brine. The brine may be natural or native brine, geothermal brine, oilfield brine, brine produced as a byproduct of clay leaching, or the like. The process of the present application may also be employed with other types of lithium source material, e.g. sea water or pregnant liquor solution generated from lithium leaching processes.

The lithium may be in any form in the lithium source material. In some embodiments of the invention, the lithium may be present in dissolved form, or may be in insoluble form. In embodiments, lithium may be present in the lithium source material in ionic form, for example as a cation. In some embodiments, lithium may be present in the lithium source material in elemental form.

Advantageously, the process of the present application permits the efficient recovery of lithium from lithium source materials comprising relatively low concentrations of lithium. In some embodiments, the lithium content of the lithium source material (e.g. brine) may be about 10000 ppm or less, about 5000 ppm or less, about 2000 ppm, about 1000 ppm or less, about 500 ppm or less, about 200 ppm or less or about 100 ppm or less. Additionally or alternatively, the lithium content of the lithium source material may be at least about 25 ppm, at least about 50 ppm or at least about 100 ppm. In embodiments, the lithium content of the lithium source material may be about 50 ppm to about 5000 ppm or about 100 ppm to about 2000 ppm.

In embodiments, the process of the invention may be repeated. In such embodiments, following step 2) of the process of the invention, and optionally simultaneously with or following step 3) of the process of the invention, the adsorbent may be contacted with a lithium source material (e.g. a brine) to provide an adsorbent having lithium being adsorbed thereon (i.e. step 1) of the process of the invention), and step 2) and 3) of the process of the invention can then be repeated, optionally without replenishment of the adsorbent.

Owing to the process of the present application resulting in negligible, if any, damage to the adsorbent, the process in such embodiments may be repeated multiple times, for example at least about 20 times, at least about 30 times, at least about 40 times, at least about 50 times or more than 50 times, optionally without replenishment of the adsorbent.

The following examples are offered by way of illustration of certain embodiments of aspects of the application herein. None of the examples should be considered limiting on the scope of the application.

### EXAMPLES

### Example 1—DLE Process

A lithium selective adsorbent comprising lithium manganese oxide was exposed to brine by contacting 100 g of lithium selective adsorbent with 2 litres of brine containing 111 ppm Li. This resulting mixture was maintained at 2 hours at 60° C. to allow the Li in the brine to be adsorbed by the selective lithium adsorbent. The adsorbent having lithium adsorbed thereupon was then contacted with a series of acid media at a weight ratio of 1 (adsorbent):10 (acid media). The acid media either comprised 0.1M acid (for abiotic acids), or 0.1M filtered supernatant obtained from culturing three microorganisms over different periods and in specific media, as shown in the table below. Two positive control samples (sulfuric acid and hydrochloric acid, at the same acid concentrations and ratios) and one negative control sample (water) were also employed.

| | |
|---|---|
| Acid Medium | Acid present |
| Sulfuric acid | Sulfuric acid |
| (positive control 1) | |
| Hydrochloric acid | Hydrochloric acid |
| (positive control 2) | |
| Water (negative | N/A |
| control) | |
| A | Gluconic acid |
| B | Acetic acid |
| C | Oxalic acid |
| D | Citric acid |
| E | Succinic acid |
| F | Itaconic acid |
| G | Gluconobacter oxydans (ATCC9844) |
| | supernatant—7 day culture in DSMZ105 growth |
| | medium |
| H | Gluconobacter diazotrophicus (DSMZ5601) |
| | supernatant—7 day culture in DSMZ105 growth |
| | medium |
| I | Aspergillus niger (proprietary) supernatant—7 day |
| | culture in DSMZ105 growth medium |
| J | Aspergillus niger (proprietary) supernatant—7 day |
| | culture in CAM growth medium |
| K | Gluconobacter oxydans (ATCC9844) |
| | supernatant—4 day culture in DSMZ105 growth |
| | medium |
| L | Gluconobacter diazotrophicus (DSMZ5601) |
| | supernatant—4 day culture in DSMZ105 growth |
| | medium |
| M | Aspergillus niger (proprietary) supernatant—4 day |
| | culture in DSMZ105 growth medium |
| N | Aspergillus niger (proprietary) supernatant—4 day |
| | culture in CAM growth medium |

The adsorbent/acid medium mixtures were added into 25 mL beakers and moderately agitated with stir bars. These mixtures were maintained under stirring for 15 minutes at a temperature of 25° C. After this maintenance period, the mixtures were filtered through a 0.22 um syringe filter.

The obtained filtrate was then prepared for inductively coupled plasma (“ICP”) elemental analysis. The ICP samples were diluted 1:10 in 2% nitric acid and a 100 uL yttrium internal standard was added to every sample. The samples were then analysed using an Optimized Rowland Circle Alignment (ORCA) ICP. The ORCA ICP provides linear detector advances that limit light loss during diffraction and optimized holographic gratings that feature 32 array detectors that can capture wavelengths between 130-770 nm.

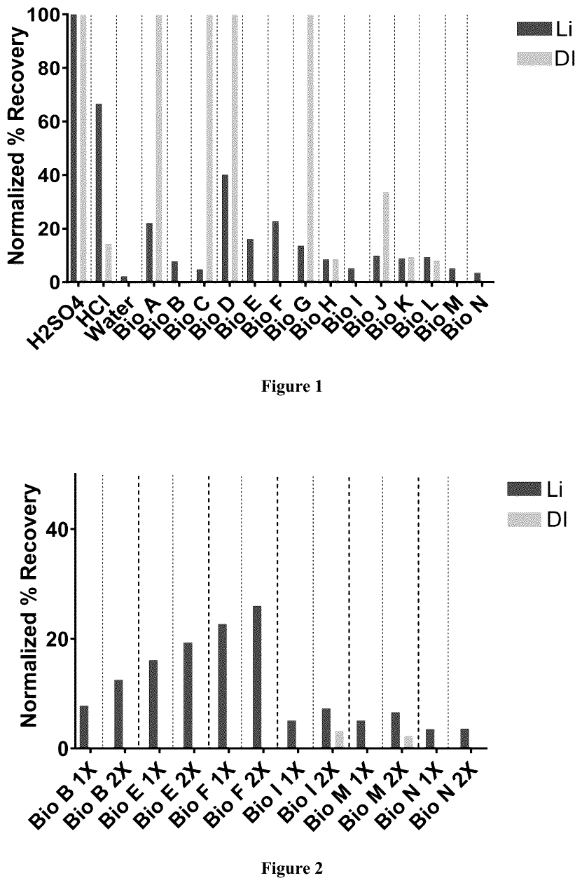

The results showing the percentage of lithium desorbed from the lithium loaded adsorbent are shown in FIG. 1 (designated ‘Li’ in that figure). Additionally, the amount of manganese detected in the filtrate was also determined (designated ‘DI’ in the figure) as the degradation of the tested adsorbent is known to liberate manganese and thus the quantity of manganese in the obtained filtrate is an indicator of degradation of the adsorbent by the acid medium. The amounts of recovered lithium and manganese were normalised against the recoveries of those metals from the sulfuric acid mixture.

As can be seen from FIG. 1, the positive and negative controls performed as expected (significant lithium recovery but also significant adsorbent degradation for the positive controls, and negligible lithium recovery/adsorbent degradation for the negative control). For the other media, A (gluconic acid), C (oxalic acid) and D (citric acid) resulted in significant adsorbent degradation, comparable to the positive controls. On the other hand, B (acetic acid), E (succinic acid) and F (itaconic acid) resulted in at least moderate lithium recovery without any observed adsorbent degradation.

Regarding the microbial acid media, supernatants produced by G (Gluconobacter oxydans), H (Gluconobacter diazotrophicus), J (Aspergillus niger), K (Gluconobacter oxydans) and L (Gluconobacter diazotrophicus) resulted in marked adsorbent degradation, while I, M and N (all Aspergillus niger) did not. Those skilled in the art will recognise that these organisms are known to produce organic acids. Organisms of the Gluconobacter genus are known to produce gluconic acid and thus the results observed for acid media G, H, K and L are not surprising given the results observed for medium A.

The results observed for media I, M and N demonstrate the utility in the process of the present application of microbial media although, comparing these to the results for medium J, the growth conditions of the microorganisms included therein may have to be controlled to optimise lithium recovery and minimise adsorbent damage.

One skilled in the art would also recognise that the acid production profile of microorganisms can be optimised in other ways, for example via genetic engineering, directed evolution and or adapted laboratory evolution.

### Example 2—Effect on Acid Concentration

A repeat of Example 1 was performed on the best performing media (B, E, F, I, M and N) from Example 1, except that the concentration of the acids/supernatants was doubled to 0.2M.

The filtrates obtained following the desorption step conducted in those studies were analysed in the same way as in Example 1 (save that the ICP samples were diluted 1:5 in 2% nitric acid). The results are shown in FIG. 2, and are normalised against the 0.1M sulphuric acid extraction in Example 1.

Encouragingly, these data confirm that increasing the concentration of acid present in the acid media resulted in a significant increase in the liberation of lithium from the absorbent (designated ‘Li’ in the figure), without any observed adsorbent degradation, i.e. release of manganese (designated ‘DI’ in the figure). A similar trend was observed with the microbial acid media except that a modest amount of adsorbent degradation was also observed. Again, one skilled in the art would be recognise that the performance of the microorganisms could be optimised through growth condition control and other techniques.

### Example 3—Repeated Desorption

To ensure that adsorbent function was not impaired by desorption, the process of the invention was repeated without replenishment of the adsorbent. Specifically, 3 g of adsorbent (a lithium selective adsorbent comprising lithium manganese oxide, loaded with lithium from brine) was mixed with 15 ml solutions of acid media B, E and F (0.1M). The adsorbent/acid media mixtures were maintained in a beaker for 15 minutes without agitation, i.e. statically, and then filtered. The filtrate was then subjected to ICP analysis.

The adsorbent was transferred to a clean beaker and contacted with 50 mL brine and agitated for 2 hours at room temperature to achieve lithium loading of the adsorbent. The adsorbent was then separated from the brine via filtration and mixed with the same acid media at the same ratio. The acid media/adsorbent mixtures were again contacted statically for 15 minutes and then filtered. The obtained filtrate was then subjected to ICP analysis.

All ICP samples were prepared in a 1:5 dilution using 2 mL of the obtained filtrates, 7.9 mL of 2% nitric acid, and 0.1 mL of Yttrium internal standard.

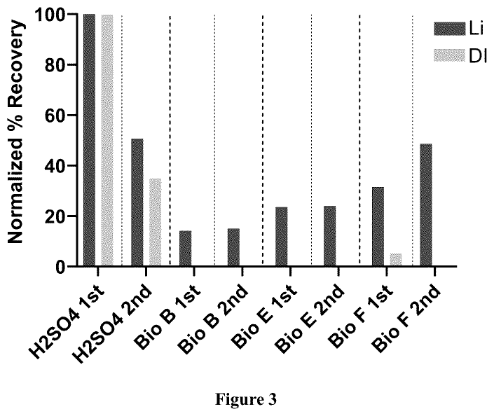

The results are shown in FIG. 3 and as can be seen, no reduction in lithium recovery (designated ‘Li’ in the figure) was observed between the first and second desorption steps conducted with the acid media of the invention, unlike the sulphuric acid desorption steps in which a notable reduction in lithium recovery was observed between the first and second desorption steps. This demonstrates that the acid media of the present application advantageously do not impact adsorbent function. In fact, the results for acid medium F (itaconic acid) showed an enhancement in adsorbent capacity for lithium following the first desorption with that medium.

The above description is for the purpose of teaching the person of ordinary skill in the art how to practice the present application, and it is not intended to detail all those obvious modifications and variations of it which will become apparent to the skilled worker upon reading the description. It is intended, however, that all such obvious modifications and variations be included within the scope of the present application, which is defined by the following claims. The claims are intended to cover the components and steps in any sequence which is effective to meet the objectives there intended, unless the context specifically indicates the contrary.

1. A method for desorbing lithium from an adsorbent having lithium adsorbed thereon, comprising:
1) providing an adsorbent having lithium adsorbed thereon;
2) contacting the adsorbent with an acid medium to desorb the lithium from the adsorbent; and
3) recovering the desorbed lithium,
wherein the acid medium comprises an organic acid having a lowest pKa value of at least about 4 and/or a dicarboxylic acid which i) comprises 3 or more carbon atoms and/or ii) has a lowest pKa value of at least about 3.5.

2. The method of claim 1, wherein the step of providing the adsorbent having lithium adsorbed thereon comprises contacting the adsorbent with a lithium source material.

3. A method for recovering lithium from a lithium source material, comprising:
1) contacting an adsorbent with a lithium source material resulting in the adsorbent having adsorbed lithium;
2) contacting the adsorbent with an acid medium to desorb the lithium from the adsorbent; and
3) recovering the desorbed lithium,
wherein the acid medium comprises an organic acid having a lowest pKa value of at least about 4 and/or a dicarboxylic acid which i) comprises 3 or more carbon atoms and/or ii) has a lowest pKa value of at least about 3.5.

4. The method of claim 3, wherein the lithium source material is brine.

5. The method of claim 4, wherein the brine comprises 50 to 5000 ppm of lithium.

6. The method of claim 3, wherein the adsorbent is contacted with the lithium source material in an adsorption zone.

7. The method of claim 3, wherein the adsorbent comprises a metal.

8. The method of claim 7, wherein the metal is aluminum, manganese or titanium.

9. The method of claim 3, wherein step 2 occurs in a desorption zone.

10. The method of claim 3, wherein the organic/dicarboxylic acid is acetic acid, succinic acid or itaconic acid.

11. The method of claim 3, wherein the acid medium comprises less than 1000 ppm of sulfuric acid, hydrochloric acid or nitric acid.

12. The method of claim 3, wherein the acid medium comprises less than 2000 ppm of sulfuric acid, hydrochloric acid and nitric acid.

13. The method of claim 3, wherein the acid medium comprises an acid producing microorganism.

14. The method of claim 3, further comprising converting the lithium desorbed from the adsorbent in Step 2 or recovered in Step 3 to an insoluble form.

15. The method of claim 14, wherein the insoluble form is a carbonate salt.

16. A kit comprising a composition comprising a pH reducing microorganism, a carrier, and instructions to use the composition in a direct lithium extraction process.
